(19) United States
(12) Patent Application Publication
(10) Pub. No.: US 2015/0100624 A1
(43) Pub. Date: Apr. 9, 2015

(54) METHOD AND SYSTEM FOR SUPPORTING VNC/RFB PROTOCOL TRANVERSAL THROUGH FIREWALLS WITHOUT THE NEED TO CONFIGURE OPEN PORTS

(71) Applicants: Richard Andrew Backhouse, Apex, NC (US); William Francis Abt, JR., Nashua, NH (US); Brian Patrick Burns, West Yarmouth, MA (US)

(72) Inventors: Richard Andrew Backhouse, Apex, NC (US); William Francis Abt, JR., Nashua, NH (US); Brian Patrick Burns, West Yarmouth, MA (US)

(73) Assignee: International Business Machines Corporation, Armonk, NY (US)

(21) Appl. No.: 14/049,482

(22) Filed: Oct. 9, 2013

(51) Int. Cl. H04L 29/08; H04L 29/06

(52) U.S. Cl. CPC H04L 67/1091; H04L 67/42; H04L 67/02; H04L 67/303; H04L 67/2804; H04L 65/1069
USPC 709/203

(57) ABSTRACT

A Virtual Network Computing (VNC) server functions as a web-based proxy server to facilitate peer-to-peer connections in a VNC environment. An objective of the web-based proxy server is to overcome limitations caused when a machine resides behind a firewall. In the configuration of the present invention, the web-based server performs the functions of a conventional client machine while a client in the peer-to-peer configuration performs the conventional server listening function.

### FIELD OF THE INVENTION

This invention relates to a method and system for connecting computing devices when one computing device is behind a firewall and in particular this invention relates to establishing a connection between a VNC server machine and a VNC client machine through a VNC proxy program executing on a web-based VNC server machine.

### BACKGROUND OF THE INVENTION

Virtual Network Computing (VNC) is a technology for remote desktop sharing. VNC technology enables the desktop display of one computer to be remotely viewed and controlled over a network connection by another computer. VNC technology is useful because it allows a user in one part of an office building or house to access their desktops from another location in that same structure. A user can even access the desk top of a machine while traveling. VNC technology is also useful for network administrators in business environments.

In network computing, the objective of a network computer (NC) is to give users access to centralized resources from simple and inexpensive devices. These network computing devices act as clients to more powerful server machines that are connected to the network. The server devices provide applications, data, and storage for a user's preferences and personal customizations.

Referring to Virtual Network Computing technology, the underlying VNC system has a protocol that facilitates remote access to graphical user interfaces. This protocol works at the frame buffer level. This protocol applies to all operating systems, windowing systems, and applications and to any device with some form of communications link. The protocol operates over any reliable transport configuration such as TCP/IP. The endpoint with which the user interacts (that is, the display and/or input devices) is called the VNC client or viewer. The endpoint where changes to the frame buffering-originate (that is, the windowing system and applications) is known as the VNC server (see FIG. 1). VNC technology is truly a “thin-client” system. Its design makes very few requirements of the client, and therefore simplifies the task of creating clients to run on a wide range of hardware.

Virtual Network Computing provides several distinctions from other computing systems. First, in a VNC system no state information is stored at the viewer (the client). This means a person can leave his/her desk, go to another machine, whether next door or several hundred miles away, reconnect to their desktop from the new machine and finish a sentence they were originally typing on the initial machine. In this case, even the cursor will be in the same place. The VNC is small and is simple technology to implement. The Win32 viewer software module, for example, is about 150K in size and can be run directly from an external storage means such as a floppy disk or flash drive. There is no need to install the software on a computing device. The next difference is that the VNC software is a truly platform-independent. A desktop running on a Linux machine may be displayed on a PC, a Solaris machine or any number of other architectures. The simplicity of the protocol makes it easy to port to new platforms. For example, a Java viewer will run in any Java-capable browser. The VNC technology is sharable. One desktop can be displayed and used by several viewers at once, allowing CSCW-style applications.

One popular application of the VNC technology is its implementation in peer-to-peer networks. A peer-to-peer (P2P) network is a type of decentralized and distributed network architecture in which individual nodes in the network (called “peers”) act as both suppliers and consumers of resources, in contrast to the centralized client-server model where client nodes request access to resources provided by central servers. In a peer-to-peer network, tasks (such as searching for files or streaming audio/video) are shared between multiple interconnected peers who each make a portion of their resources (such as processing power, disk storage or network bandwidth) directly available to other network participants, without the need for centralized coordination by servers.

One issue that occurs regarding VNC technology is the use of the VNC technology behind a firewall. If a VNC server is setup behind a firewall, the TCP/IP port needed for the connection must be opened in the firewall configuration. If a peer to peer application uses VNC/RFB for sharing machine resources, then this required firewall configuration can be a limitation for enabling easy setup of the software. There remains a need for a VNC configuration that can establish peer-to-peer connections that overcome the limitations of a firewall when at least one peer machine is behind the firewall.

### SUMMARY OF THE INVENTION

The present invention describes a system and method for establishing peer-to-peer connections across a firewall. This system configuration comprises at least one VNC server residing on a computing machine, a VNC client residing on at least one second computing machine and a VNC proxy server residing in a web-server on a communication network that can function as both the VNC server machine and VNC client machine. The location of the VNC proxy server in the web server overcomes firewall limitations of a VNC server in a peer machine that is behind a firewall. The present invention also reverses the conventional functions of the VNC server and VNC client during a VNC connection. In this configuration of the present invention, the proxy VNC server establishes a connection with a VNC peer machine that is initiating a share request and performs the control functions typically performed by the VNC peer client. Also in the configuration of the present invention, a VNC peer client performs the listening function.

In the method of the present invention, each VNC peer machine has a web page from the VNC proxy that each VNC peer machine uses to initiate a share request. The information on the individual VNC peer machine web pages gives the VNC proxy server information about each peer machine in the system. The VNC peer share request is initiated by a VNC peer machine and with the web-server and VNC proxy server. Once a connection is established between a VNC peer machine and the VNC proxy server, each peer machine is notified of the share request. Each peer machine has the capability to be in a listening mode for any such notification. When a VNC client machine indicates a desire to connect and share, the VNC proxy detects a client request to connect and VNC protocols are initiated. The client machine can send mouse and keyboard information from to the VNC proxy server. The VNC proxy server returns frame buffer information to the client machines. Client machine uses this frame buffer information to display a view of the user interface shown on the peer sharing machine.

### DESCRIPTION OF THE DRAWINGS

FIG. 1 shows a conventional connection between server machine and client machines.

FIG. 2 is a flow diagram of a conventional exchange to establish a connection between a VNC server machine and a VNC client machine.

FIG. 3 shows a web-based peer-to-peer VNC network configuration of the present invention having a VNC proxy server.

FIG. 4 shows a web-based peer-to-peer Virtual Network Computing (VNC) connection between a VNC server and a VNC client with a firewall in front of the VNC server.

FIG. 5 is a flow diagram of a VNC peer-to-peer exchange to establish a connection between a VNC server machine and a VNC client machine via a web-based VNC server.

### DETAILED DESCRIPTION OF THE INVENTION

The present invention describes a system and method for establishing peer-to-peer connections across a firewall. In a conventional configuration, if a virtual network configuration (VNC) server is setup behind a firewall the TCP/IP port [Transmission Control Protocol (TCP) and Internet Protocol (IP)] needed for the connection must be opened in the firewall configuration. If a peer-to-peer application uses the VNC/RFB for sharing machine resources then the required firewall configuration can be a limitation for enabling easy setup of the software.

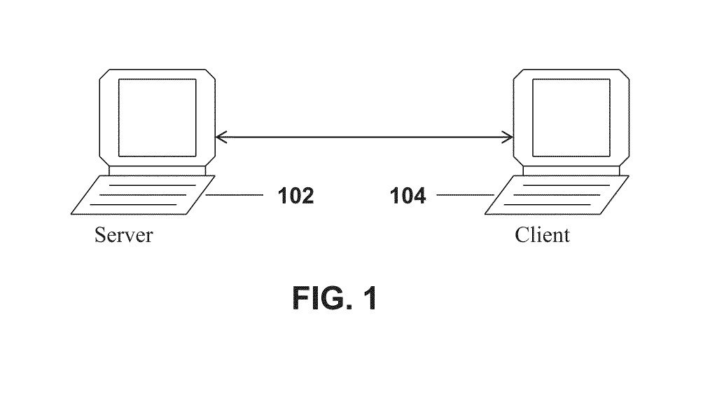

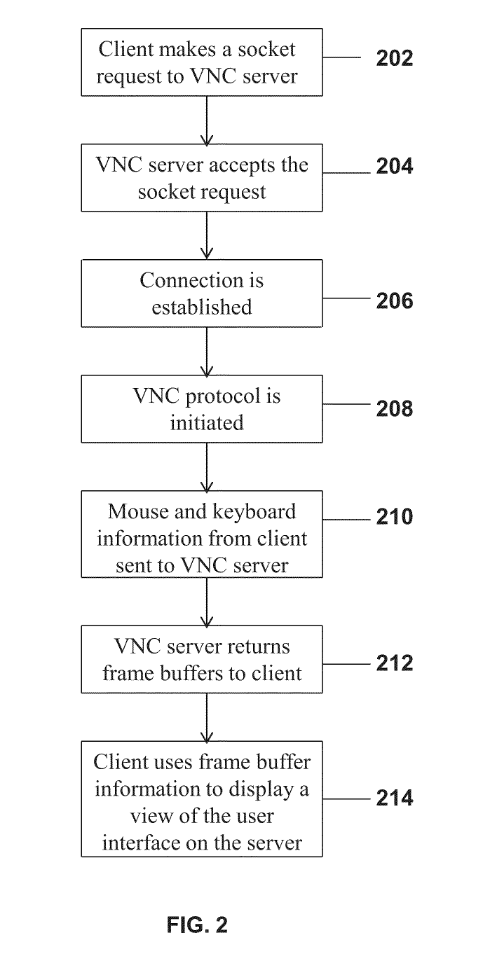

Referring to FIG. 1, shown is a conventional connection between server machine 102 and client machine 104. In this configuration, the VNC server module runs on one machine 102 and the client module runs on the second machine 104. FIG. 2 show a flow diagram of a conventional exchange to establish a connection between a VNC server machine and a VNC client machine. In this connection method, if there is a desire for a user of one machine to share resources with another machine, there must be a connection between these two machines. These two machines are the client machine and the server machine. In this method, the client makes a socket request to connect to the VNC server in step 202. In step 204, the VNC server accepts the socket request. At this point, the connection of the two machines is established in step 206. After the connection of the two machines, step 208 initiates the VNC protocol. In this VNC protocol, step 210 sends mouse and keyboard information from the VNC client machine to the VNC server. Also, the VNC server returns frame buffer information to the client machine in step 212. These frame buffers are updates and changes to the VNC server screen. The screen changes are mainly particular bits on the screen. In step 214, the client machine uses this frame buffer information to display a view of the user interface shown on the VNC server. Referring back to steps 202 and 204, as mentioned, in order to efficiently make these connections, the TCP/IP ports on the VNC server machines must be kept open. A firewall in the VNC server configuration can create a limitation to efficient peer-to-peer connections.

In the present invention, instead of the VNC server itself performing the TCP/IP socket “accept” as shown in step 204, a service running within a VNC proxy listens for incoming VNC connection requests. In many network configurations, the VNC server may be behind a firewall, which could limit a machine's ability to connect to the listening VNC server. In the present invention, the VNC proxy resides in the Web server which is not behind a firewall.

When a peer-to-peer application needs to start sharing its screen it starts a VNC server that will open a TCP/IP socket and connect to the VNC proxy. After this connection, the RFB protocol is followed as normal.

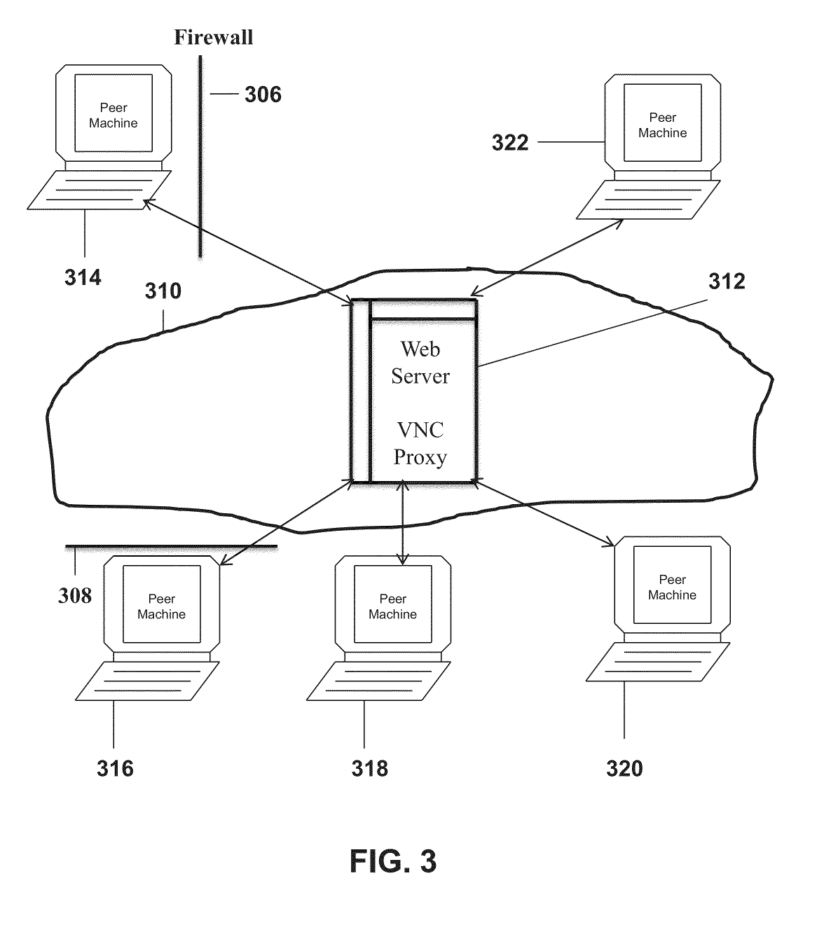

FIG. 3 shows a web-based peer-to-peer VNC network configuration of the present invention having a VNC proxy server. As shown, a web-server 312 resides in a communication network 310. Within the web-server 312 is a VNC proxy server module. Peer machines 314, 316, 318, 320 and 322 all connect to the VNC server machine through the communication network. A VNC server module resides in and executes in each peer machine. Each machine can connect to the web-server via the communication network 310. As shown, in this configuration, peer machines 314 and 316 are located behind firewalls 306 and 308. In the conventional configuration, when the VNC server in the peer machine 314 is listening for connections, the firewall 306 could interfere with and/or block the connection attempt. In the configuration of the present invention, the VNC proxy module in the web server performs the listening function for the peer machines in the network.

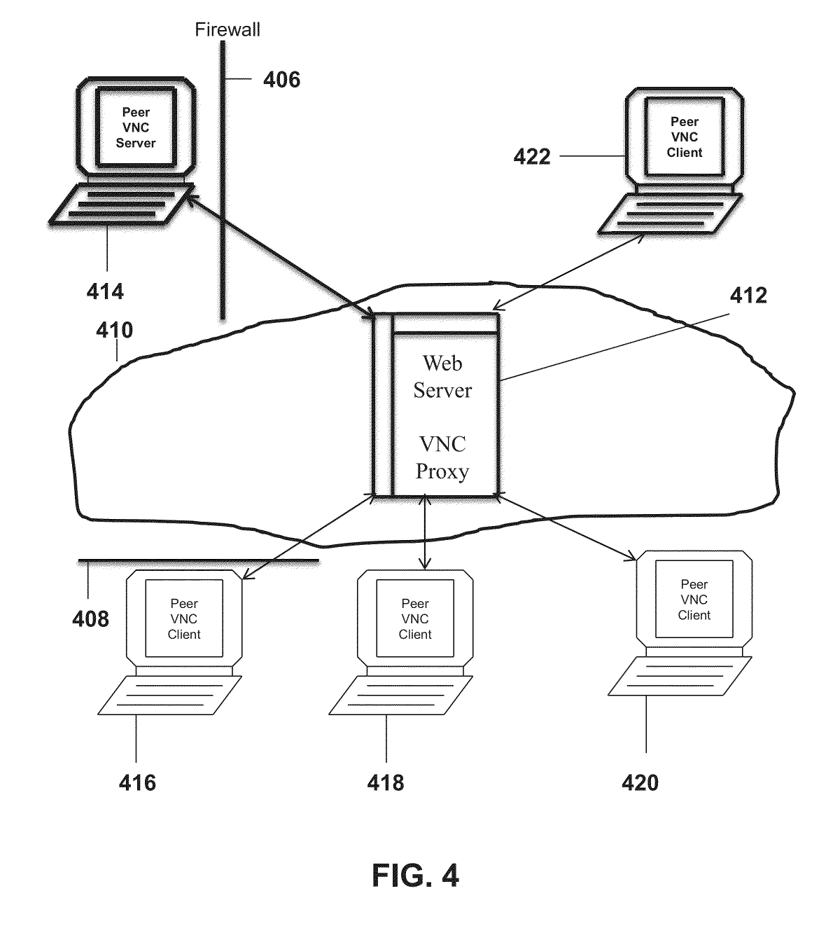

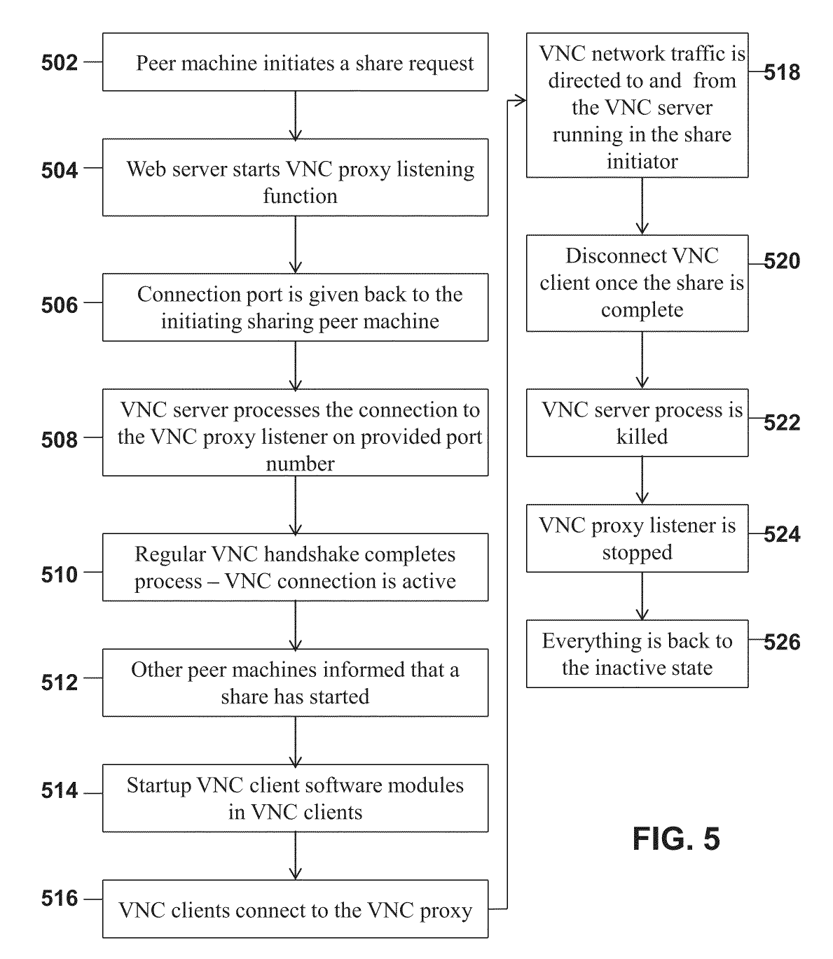

FIG. 4 shows a web-based peer-to-peer Virtual Network Computing (VNC) connection between a VNC server 414 and a VNC client 422 with a firewall 406 in front of the VNC server 414. FIG. 5 illustrates the method of a VNC peer-to-peer exchange to establish a connection between a VNC server machine and a VNC client machine through a web-based VNC proxy server. As shown in FIG. 4, there is a web server 412 on a communications network 410 in which a VNC proxy server resides. Peer machines 414, 416, 418, 420 and 422 can connect to the web server 412 via the communications network 410. In the configuration in FIG. 4, peer machines 414 and 416 are behind firewalls 406 and 408 respectively. Within each peer machine resides a VNC server software module and a VNC client software module. In this configuration, each peer machine downloads a share page from the web-server.

Referring to FIG. 5, peer machine 414 desires to share its screen access and contents. The primary peer machine for the screen sharing can be peer machine 422 however any peer machine in that session can interact with peer machine. In this process, the user of peer machine 414 can initiate a share request by pressing a ‘Share’ button associated with the downloaded share page for that peer machine. This share request initiation occurs in step 502. The share from peer machine 414 goes to the web-server 412. Based on the downloaded share page, the web-server can identify the peer machine making this share request as peer machine 414. At this point, in step 504, the web-server 412 initiates the VNC proxy listening program. Once initiated, the VNC proxy will create a socket port on which the VNC proxy will listen for peer-to-peer requests from peer machine 414. The created socket port will have a port number that identifies the port which will connect the peer machine 414 and the VNC proxy. This port is the port on which the VNC proxy listening function will occur. In step 506, the VNC proxy sends the connection port number back to the peer machine 414 initiating the share request. In step 508, the VNC server at the peer machine processes the connection to the VNC proxy listener on the provided port number. At this point, in step 510 regular VNC handshake protocols complete the connection process. This protocol can be a standard Remote Frame Buffer (RFB) protocol. This RFB protocol is a well defined protocol. This protocol comprises a set of messages transmitted between the client and the server, once a connection is made. These messages establish how the machines will talk to each other and other security between the machines. At the completion of these handshake protocols, the VNC connection between the requesting peer machine 414 and the VNC proxy is active.

Once the VNC connection becomes active, step 512 informs other peer machines that a share process has been started at peer machine 414. Step 514 then initiates VNC client software modules on browsers in the other peer machines. These peer machines that share with peer machine 414 will function as client machines.

Step 516 connects the VNC client machines that want to share to the VNC proxy. This step illustrates the distinction between the process of the present invention and the conventional VNC server connection. In the conventional machine to machine system, the VNC server in the machine initiating the share would be listening for clients that wanted to connect. As mentioned, if the VNC server was behind a firewall, the firewall could interfere with a VNC server to VNC client connection. In the system of the present invention, the VNC proxy residing on the web-server is doing the listening for VNC clients that want to connect to the sharing peer. This listening occurs outside the firewall of the peer machines initiating the share request.

The client connection to the VNC proxy can be similar to a conventional peer-to-peer connection as described in FIG. 2. After the VNC proxy detects a client request to connect, VNC protocols are initiated. The client machines send mouse and keyboard information from to the VNC proxy server. The VNC proxy server returns frame buffer information to the client machines. As mentioned, these frame buffers are updates and changes to the VNC server screen. The screen changes are mainly particular bits on the screen. Client machine use this frame buffer information to display a view of the user interface shown on the peer sharing machine.

Once the client machines are connected to the peer sharing machine 414 via the VNC proxy server in the web-server 412, the peer-to-peer sharing function begins in step 518. In this sharing function, VNC network traffic is directed to and from the VNC server running in the share initiator (the peer sharing machine 414). The traffic flows through the VNC proxy as part of the flow of traffic between the sheering peer machine 414 and the connected client machines. The connect client machines could be one machine 422 or all client machines in the network.

When the sharing session is complete, the process to terminate the VNC connections begins. First, step 520 disconnects the VNC client. Step 522 then terminates the server process between the sharing peer machine 414 and the VNC proxy on the web-server. Step 524 stops the VNC proxy listener. At this point, step 526 sends all functions of the system to inactive states.

It is important to note that while the present invention has been described in the context of a fully functioning data processing system, those skilled in the art will appreciate that the processes of the present invention are capable of being distributed in the form of instructions in a computer readable storage medium and a variety of other forms, regardless of the particular type of medium used to carry out the distribution. Examples of computer readable storage media include media such as EPROM, ROM, tape, paper, floppy disc, hard disk drive, RAM, and CD-ROMs.

We claim:

1. A system for supporting virtual network computing protocol traversal through a firewall without configuring open ports comprising:
a network server (VNC web server) residing on a communication network, said VNC web server capable of connecting to and communicating with computing machines connected to the communication network;
a virtual network computing proxy module residing in said VNC web server, said virtual network computing proxy module functioning as a proxy server to establish connections between computing machines on the communication network;
a plurality of peer computing machines connected to said VNC web server on the communication network, such that peer-to-peer communications can be established between at least any two of said plurality of peer computing machines via said VNC web server;
a virtual network computing server software module for performing network server functions in a virtual network computing configuration; and
a virtual network computing client software module for performing network client functions in a virtual network computing configuration, said a virtual network computing client software module residing in each of said a plurality of peer computing machines.

2. The system for supporting virtual network computing protocol traversal through a firewall as described in claim 1 further comprising a web page in each of said plurality peer computing machines connected to said VNC web server, each web page containing profile information of the peer machine in which said web page resides.

3. The system for supporting virtual network computing protocol traversal through a firewall as described in claim 2 wherein a said virtual network computing server software module resides in each of said a plurality of computing machines connected to said VNC web server on the communication network.

4. The system for supporting virtual network computing protocol traversal through a firewall as described in claim 2 wherein a said virtual network computing client software module resides in each of said a plurality of computing machines connected to said VNC web server on the communication network.

5. The system supporting virtual network computing protocol traversal through a firewall as described in claim 2 wherein said VNC web server has client module capabilities for functioning in a virtual network computing environment.

6. A method for supporting virtual network computing protocol traversal through a firewall without configuring open ports comprising:
configuring a virtual computing network (VNC) compromising web server residing on a communication network, said web server capable of connecting to and communicating with a plurality of peer computing machines connected to the web server, said web server having the capability to function as a proxy server to establish connections between peer computing machines;
detecting at the web server, a share request from one of said plurality of peer computing machines connected to the web server;
initiating at the web server, a VNC proxy listening module residing in the web server;
processing a connection request at the VNC proxy module as part of the share request;
alerting other peer computing machines of the share request;
initiating VNC client software modules in the peer machines;
listening at the proxy server for peer machines responding to the share request from the peer machine initiating the share request;
connecting client peer machines, responding to the share alert, to the proxy server; and
establishing share capabilities between machines through the proxy server.

7. The method for supporting virtual network computing protocol traversal through a firewall without configuring open ports as described in claim 6 wherein said detecting a share request further comprises:
creating a socket port on which the proxy server will listen for peer-to-peer requests and through which peer machines will connect with the proxy server; and
sending a number for the created connection port number back to the peer machine initiating the share request.

8. The method for supporting virtual network computing protocol traversal through a firewall without configuring open ports as described in claim 6 wherein said configuring a virtual computing network (VNC) further comprises establishing a share web page at each peer machine, the peer web page having information about the particular peer machine where the web page resides, information on a web page enables the proxy server to identify each peer machine.

9. The method for supporting virtual network computing protocol traversal through a firewall without configuring open ports as described in claim 6 further comprising after said establishing share capabilities between machines through the proxy server, sharing information at the peer machine initiating the share request with peer machines connected to the initiating peer machine via the proxy server.

10. The method for supporting virtual network computing protocol traversal through a firewall without configuring open ports as described in claim 6 wherein said connecting peer machines further comprises:
sending client peer machine mouse and keyboard information from each client peer machine to the proxy server; and
sending frame buffer information from the proxy server to each connected client peer machine.

11. The method for supporting virtual network computing protocol traversal through a firewall without configuring open ports as described in claim 9 further comprising after said sharing information at the peer machine initiating the share request with peer machines connected to the initiating peer machine via the proxy server:
detecting completion of an information sharing between the peer machines;
disconnecting peer client machines from the proxy server; and
terminating functioning of the proxy server at the web server.

12. The method for supporting virtual network computing protocol traversal through a firewall without configuring open ports as described in claim 11 further comprising after said terminating functioning of the proxy server, returning system components to an inactive state.
